(19) United States
(12) Patent Application Publication
(10) Pub. No.: US 2014/0344606 A1
(43) Pub. Date: Nov. 20, 2014

(54) Electronic System and Method for Starting Electronic System Through CEC

(71) Applicant: Fortune Advance Development Limited, British Virgin Islands (GB)

(72) Inventor: Sheng-Yang HUANG, Harvey (AU)

(21) Appl. No.: 13/897,457

(22) Filed: May 20, 2013

(51) Int. Cl. G06F 1/32

(52) U.S. Cl. CPC G06F 1/3234; G06F 1/3287
USPC 713/324; 713/300; 713/320

(57) ABSTRACT

A method for starting an electronic system through CEC is disclosed, in which the electronic system includes a power management controller and a processing circuit controlled by the power management controller. In the method, a CEC bus which is electrically connected to the power management controller is detected, and a CEC data transmitted from the CEC bus is compared with a pre-determined logic value. After that, the processing circuit is powered on when the CEC data is equal to the pre-determined logic value.

### BACKGROUND

1. Field of Invention

The present invention relates to a method for starting an electronic system. More particularly, the present invention relates to a method for starting an electronic system through consumer electronics control (CEC).

2. Description of Related Art

Advancements in consumer electronic devices have led to a wide variety of such devices that may be powered by AC (alternating current) and DC (direct current) power sources, such as an electrical outlet in a home. Many such devices are placed in a standby mode when not being operated. In the standby mode, these devices typically continue to require some power and draw (sink) some current. Further, some devices may continue to perform certain operations even when in the standby mode. For example, a set top box (STB) may be monitoring its receiver or other input even when the STB is in the standby mode.

Many electronic devices are provided with a function which allows some parts to be woken up from a low power state if a request is received. In order to accomplish this function, the electronic devices must be able to detect if such a request is received. Usually, polling is used to detect the request. Sometimes, the circuit part which needs to be woken up also needs to be supplied with some level of power in order to receive the wake up request. These actions all result in an increase in power consumption.

### SUMMARY

According to one embodiment of the present invention, a method for starting an electronic system through CEC is disclosed. In the method, pre-determined logic value is loaded into a storage device of a power management controller when the electronic system is started for the first time, and a processing circuit which processes data and a plurality of instructions is powered off after the pre-determined logic value has been loaded.

According to another embodiment of the present invention, a method for starting an electronic system through CEC is disclosed, in which the electronic system includes a power management controller and a processing circuit controlled by the power management controller. In the method, a CEC bus which is electrically connected to the power management controller is detected, and a CEC data transmitted from the CEC bus is compared with a pre-determined logic value. After that, the processing circuit is powered on when the CEC data is equal to the pre-determined logic value.

According to another embodiment of the present invention, a method for starting an electronic system through CEC is disclosed. In the method, a pre-determined logic value is loaded into a storage device of a power management controller, and a processing circuit is set to a low power state after the pre-determined logic value has been loaded. Next, a CEC bus which is electrically connected to the power management controller is detected, and a CEC data transmitted from the CEC bus is compared with the pre-determined logic value. The processing circuit is woken up when the CEC data is equal to the pre-determined logic value.

According to yet another embodiment of the present invention, an electronic system is disclosed. The electronic system includes a first electronic device that processes data and instructions, in which the first electronic device includes a power management controller and a processing circuit.

The power management controller controls power states based on CEC data that is received from a CEC bus, in which the power management controller includes a storage device and a logic circuit. The storage device is configured to store a pre-determined logic value, and the logic circuit is configured to compare the pre-determined logic value and the CEC data that is received from the CEC bus.

The processing circuit is electrically connected to the power management controller and is controlled to operate by the power management controller. The processing circuit is set to a low power state after the pre-determined logic value is loaded into the storage device of the power management controller.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of an electronic system according to one embodiment of the present invention;

FIG. 2 is a block diagram of an electronic system according to another embodiment of present invention;

FIG. 3 is a flowchart of a method for starting an electronic system through CEC according to one embodiment of the present invention;

FIG. 4 is a flowchart of a method for starting an electronic system through CEC according to one embodiment of the present invention;

FIG. 5A is a flowchart of a method for starting an electronic system through CEC according to another embodiment of the present invention; and

FIG. 5B is a flowchart of a method for starting an electronic system through CEC according to yet another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The following embodiments involve loading a pre-determined logic value to be compared when an electronic system is started for the first time, and a processing circuit is set to a low power state and is woken up to operate only if a Consumer Electronics Control (CEC) data that is received is equal to the loaded pre-determined logic value. Through such operation, power consumption is reduced.

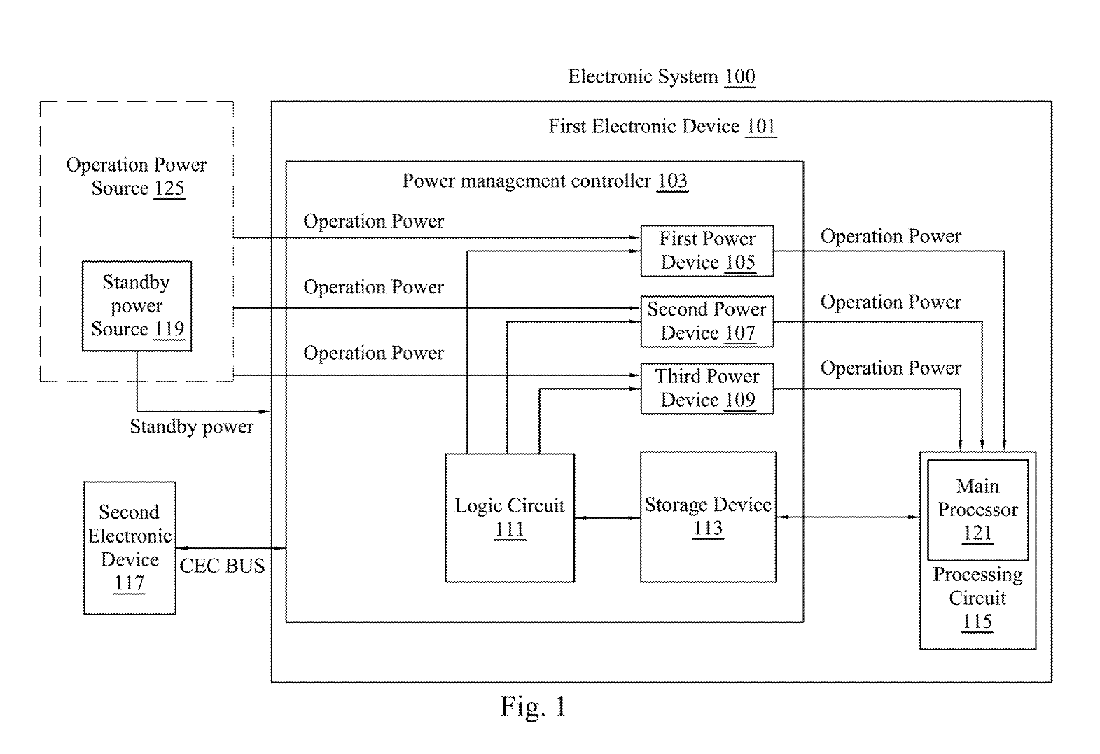

FIG. 1 is a block diagram of an electronic system according to one embodiment of the present invention. The electronic system 100 includes a first electronic device 101, a second electronic device 117, and a standby power source 119 which provides standby power for the electronic system 100.

The first electronic device 101 can be any kind of circuit or product that can process data and instructions. The first electronic device 101 which processes data and instructions includes a power management controller 103 controlling power states based on CEC data received from a CEC bus, and a processing circuit 115 electrically connected to the power management controller 103.

The power management controller 103 includes a storage device 113 and a logic circuit 111. The storage device 113 is configured to store a pre-determined logic value. The storage device 113 can be all types of non-volatile memories such as a flash memory or an electrically-erasable programmable read-only memory (EEPROM). The storage device 113 can also be all types of volatile memories such as registers, flip flops, or a SRAM (Static random-access memory). The logic circuit 111 is configured to compare the pre-determined logic value and the CEC data received from the data bus. In some embodiments, the logic circuit 111 includes a plenty of flip flops, combination circuits (both not shown) for arithmetic computing, and logic gates, such as AND gates, OR gates, NOR gates, etc.

The processing circuit 115 includes a main processor 121 configured to process video data, audio data, and instructions. The processing circuit 115 is electrically connected to the power management controller 103 and is controlled to operate by the power management controller 103. The processing circuit 115 is set to a low power state, such as a power off state or a sleep state, after the pre-determined logic value is loaded into the storage device 113 of the power management controller 103. When the CEC data that is received is equal to the pre-determined logic value, the processing circuit 115 is either woken up from the low power state to an operation state by the power management controller 103 (if the processing circuit 115 is not totally powered off previously) or powered on by the power devices (if the processing circuit 115 is powered off previously). In this embodiment, the low power state can be a power off state or a sleep state, and the power off state is preferred. Through such a mechanism, the processing circuit 115 does not consume power when it is set to the low power state, such that power consumption is further reduced.

In addition, the power management controller 103 further includes a first power device 105, a second power device 107, and a third power device 109, each of which is electrically connected to the logic circuit 111 and the processing circuit 115. The first, second, and third power devices 105, 107, 109 are power devices (e.g., DC-DC converters) that supply power to the processing circuit 115 based on the comparison of the CEC data and the pre-determined logic value. When CEC data and the pre-determined logic value are determined to be equal, the power devices are first turned on, then the main processor 121 is woken up by the power management controller 103 and powered by the first, the second, and the third power devices (105, 107, 109), that is, the power devices will provide operation power for the main processor 121, such as a higher voltage, to the processing circuit 115.

The second electronic device 117 is a product, such as a DVD player or a STB), which can wake up the first electronic device 101 from the low power state. In this embodiment, the second electronic device 117 is a circuit which utilizes a CEC bus to transmit data, and the CEC data is outputted from second electronic device 117 and is sent to the first electronic device 101 through the CEC bus.

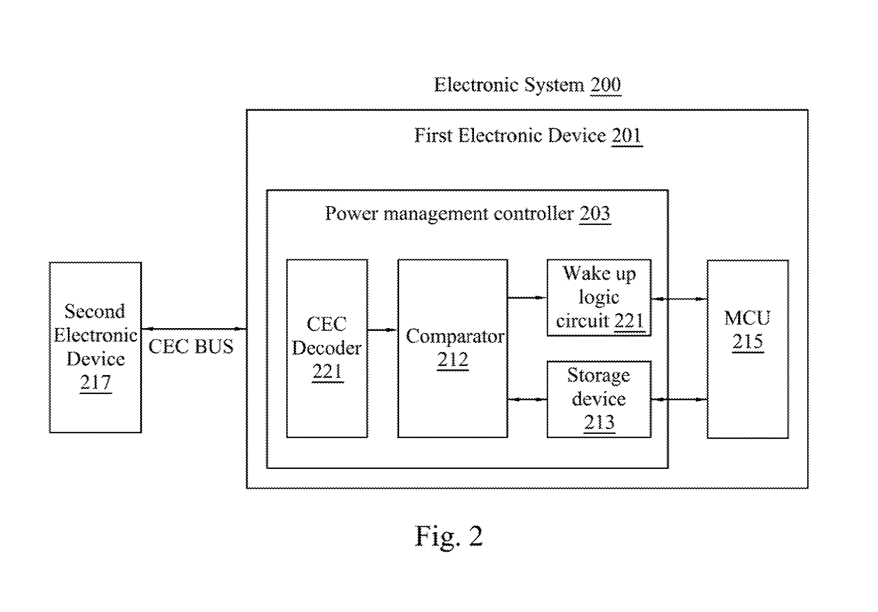

FIG. 2 is a block diagram of an electronic system according to another embodiment of present invention. The electronic system 200 includes a first electronic device 201 and a second electronic device 217.

The first electronic device 201 can be any kind of circuit or product that can process data and instructions, such as a-TV, a system unit of a desktop computer, a processing part of a notebook, or a processing part of a smart phone. The first electronic device 201 includes a power management controller 203 which controls power states based on CEC data received from a CEC bus and a micro control unit (MCU) 215 electrically connected to the power management controller 203.

The micro control unit 215 can include a processor based mixed-signal application integrated circuit (not shown) that is typically referred to as a system on a chip (SOC). In some embodiments, the micro control unit 215 includes a processor of the 8051 type with a flash memory. Such an SOC integrated circuit is typically directed toward instrumentation type applications that require an interface with sensors, etc., and which can perform processing of information from these sensors in a digital domain.

In some applications of MCU-based SOCs, there is a requirement for a low power mode of operation. Thus, these SOCs have what is termed a “sleep mode” associated therewith. The sleep mode allows the SOC to be placed in a very low power mode of operation, in which partial operations are suspended or halted to conserve power. There are a number of ways to implement the sleep mode of operation. The first is a complete power down of the chip, in which the configuration information, etc. can be stored in an on-chip memory prior to power down. This is the lowest power mode of operation since there is virtually no current drawn when the chip is powered down.

The power management controller 203 includes a CEC decoder 221, a comparator 212, a wake up logic circuit 221, and a storage device 213. The storage device 213 is configured to store a pre-determined logic value. The storage device 213 can be a non-volatile memory or a volatile memory such as registers, flip flops, or a SRAM. When the electronic system 200 is started for the first time, a pre-determined logic value, such as 00FF (hex) is loaded from MCU 215 to the storage device 213. In other embodiments, the pre-determined logic value can be loaded into (i.e., stored in) the storage device 213 through a recording process during the manufacture of the electronic system 200. After the loading of the pre-determined logic value, the MCU 215 is powered off, and the MCU 215 does not consume power until it is woken up by the wake up logic circuit 213. Hence, power consumption is reduced by such operation.

The CEC decoder 221 is used to decode packages transmitted from the CEC bus in order to extract CEC data from the packages. The comparator 212 is configured to compare the pre-determined logic value stored in the storage device 213 and the CEC data received from the CEC decoder 221. In some embodiments, the comparator 212 includes combinational logic circuits (not shown), such as gate circuits, to perform the comparing. When the pre-determined logic value and the CEC data are determined to be equal, the wake up logic circuit 221 will turn on power devices) and wake up the MCU 215 from the low power state and set it to the operation state. In the operation state, the MCU 215 is supplied with larger power consumption.

The second electronic device 217 is a circuit or a product which can wake up the first electronic device 201 from the low power state, such as a power off state or a sleep state. In this embodiment, the second electronic device 217 is a High Definition Multimedia Interface (HDMI) device which utilizes a CEC bus to transmit data. Specifically, the second electronic device 217 can be a multimedia player, such as a DVD (Digital Versatile Disc) player, a DVD recorder, a VCD (Versatile Compact Disc) player, or a set top box. The CEC data is outputted from second electronic device 217 to the first electronic device 201 through the CEC bus. For example, if a tray with an optical disk disposed thereon is pushed into the DVD player, a CEC data is generated and outputted by the DVD player.

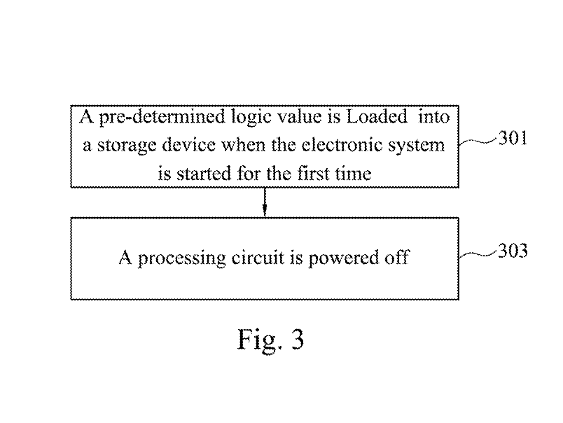

FIG. 3 is a flowchart of a method for starting an electronic system through CEC according to one embodiment of the present invention. In the method, a pre-determined logic value, such as 0xff (hex), is loaded into a storage device of a power management controller when the electronic system is started for the first time (step 301). Specifically, when the electronic system is electrically connected to a power supply and is powered by the same for the first time, a pre-determined logic value is loaded from a processing circuit into the storage device. After the pre-determined logic value is loaded, the processing circuit which processes data and instructions is powered off to reduce power consumption (step 303). The standby power unit is no longer required for the processing circuit in this situation.

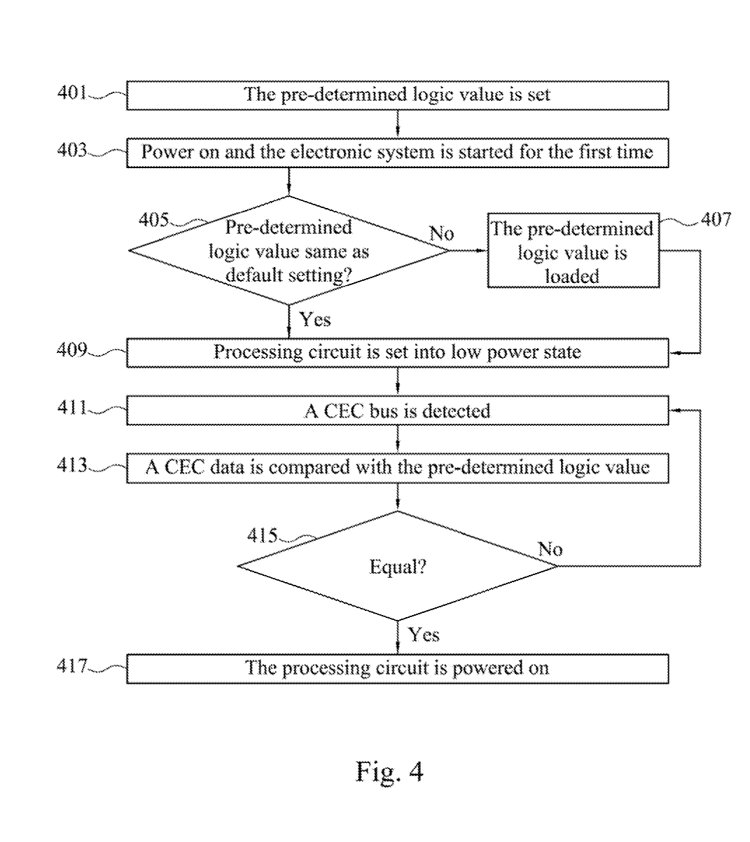

FIG. 4 is a flowchart of a method for starting an electronic system through CEC according to one embodiment of the present invention. In this embodiment, the electronic system includes a power management controller and a processing circuit controlled by the power management controller. In the method the pre-determined logic value is set in first (Step 401). Specifically, it can be set by an user. For example, the pre-determined logic value can be set to 0x0ff (hex) by an user. Next, the electronic system is powered on and is started for the first time (step 403).

There are various ways to put the pre-determined logic value into the storage device of the power management controller. One way is to store the pre-determined logic value in a storage device of the power management controller before the electronic system is started for the first time, that is, the pre-determined logic value is inherently built in. Another way is to load the pre-determined logic value from the processing circuit into a storage device of the power management controller when the electronic system is started for the first time.

In this embodiment, the set pre-determined logic value is checked if it is equal to a default setting (step 405). When the set pre-determined logic value is equal to a default setting, the loading step is not necessary and is skipped, and the processing circuit is set to a low power state which can be a power off state or a sleep state (step 409). When the set pre-determined logic value is not equal to the default setting, the pre-determined logic value is loaded from the processing circuit into a storage device of the power management controller (step 407).

Next, a CEC bus which is electrically connected to the power management controller is detected (step 411), and a CEC data transmitted from the CEC bus is compared with the pre-determined logic value (step 413) and is checked if they are equal (step 415). After that, the processing circuit is powered on when the CEC data is equal to the pre-determined logic value (step 417). Otherwise, the processing circuit is kept in the low power state.

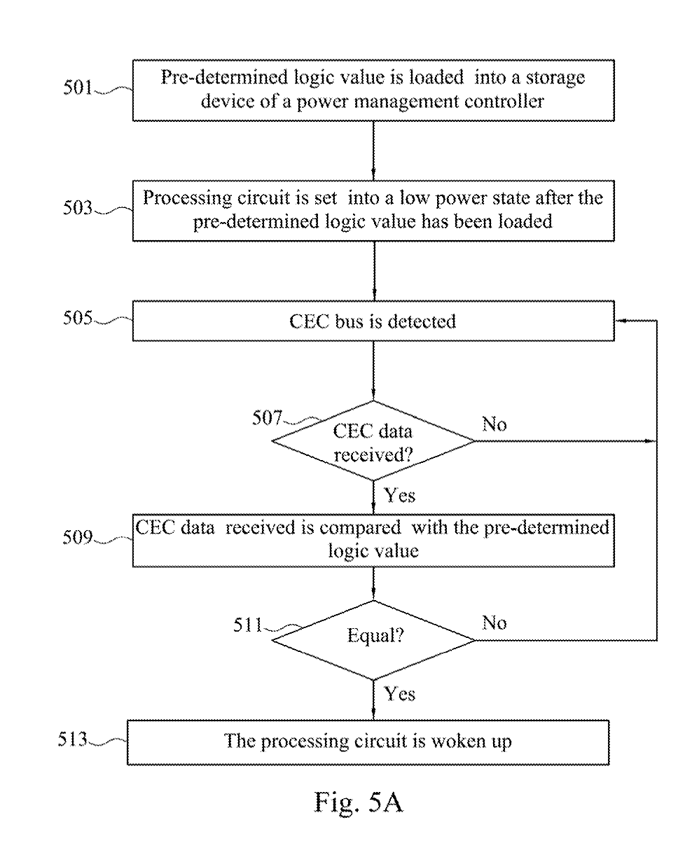

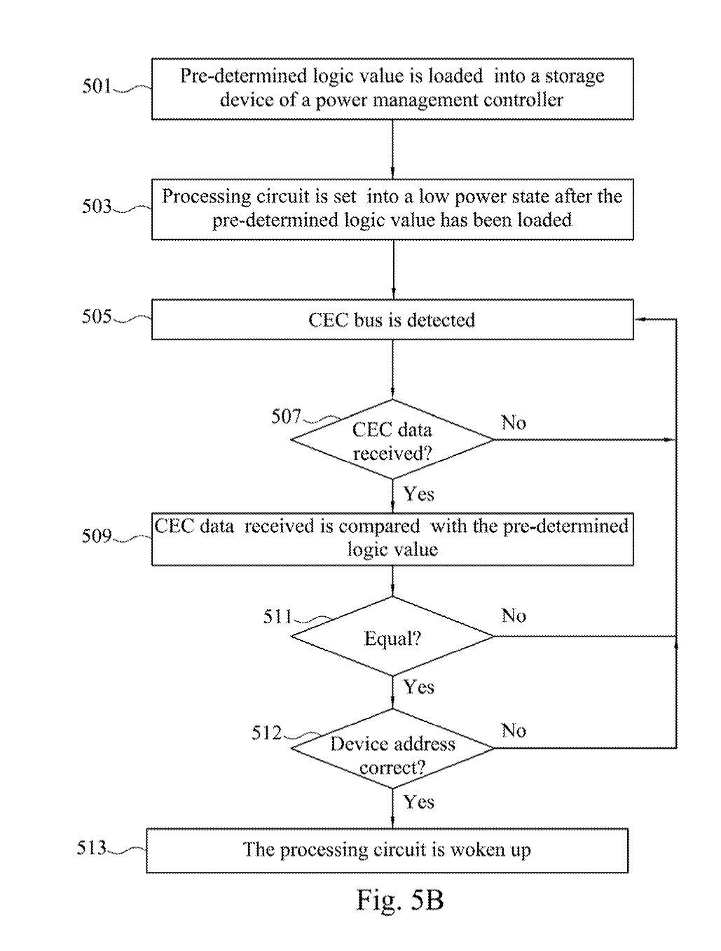

FIG. 5A is a flowchart of a method for starting an electronic system through CEC according to another embodiment of the present invention. In the method, a pre-determined logic value is loaded into the storage device of a power management controller (step 501). In greater detail, the pre-determined logic value can be loaded from a processing circuit into the storage device when the electronic system is started for the first time. In some embodiments, the pre-determined logic value can be loaded into (i.e., stored in) the storage device of the power management controller through a recording process before the electronic system is started for the first time.

The processing circuit is set to a low power state after the pre-determined logic value has been loaded (step 503). In this embodiment, the processing circuit is set to a power off state or a sleep state, and a standby power source is no longer required for the processing circuit, which further reduces power consumption.

After step 503, a CEC bus which is electrically connected to the power management controller is detected (step 505), and a determination is made as to whether a CEC data is received (step 507). If there is no CEC data, step 505 is repeated (i.e., the flow returns back to step 505).

If the CEC data is received from the CEC bus, it is compared with the pre-determined logic value (step 509), and it is subsequently determined if the CEC data is equal to the pre-determined logic value (step 511). In this embodiment, since power states are controlled according to the value of the CEC data, operation states of the processing circuit do not need to be polled. Specifically, the CEC data and the pre-determined logic value are not compared through software but through logic circuits such as combinational circuits and sequential circuits. Therefore, the MCU is not required for the comparison. If the CEC data and the pre-determined logic value are determined to be equal, the processing circuit is woken up from the low power state and performs the starting sequence (step 513).

FIG. 5B is a flowchart of a method for starting an electronic system through CEC according to yet another embodiment of the present invention. In this embodiment, the steps are almost the same as the steps of the method depicted in FIG. 5A, except that an additional step 512 is included in this embodiment. In this embodiment, when the CEC data received is determined to be equal to the pre-determined logic value in step 511, the device address of the second electronic device which outputs the CEC data is further checked to determine if it is correct (step 512). When the device address is correct, which means the device outputting the CEC data is the expected device, the processing circuit is woken up. If the device address is not correct, the flow goes back to step 505 to repeat the step of detecting the CEC bus.

In the above embodiments, a pre-determined logic value is first loaded for comparison, and the processing circuit is set to a low power state after the pre-determined logic value is loaded. Such operation saves power. The processing circuit is woken up only if a CEC data equal to the pre-determined logic value is received. As a result, it is not necessary to place the processing circuit in a standby mode, which further reduces power consumption.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for starting an electronic system through CEC, comprising:
loading a pre-determined logic value into a storage device of a power management controller when the electronic system is started for the first time; and
powering off a processing circuit which processes data and a plurality of instructions after the pre-determined logic value has been loaded.

2. The method as claimed in claim 1, wherein the pre-determined logic value is loaded from the processing circuit into the storage device when the electronic system is started for the first time.

3. A method for starting an electronic system through CEC, wherein the electronic system comprises a power management controller and a processing circuit controlled by the power management controller, the method comprising:
detecting a CEC bus which is electrically connected to the power management controller;
comparing a CEC data transmitted from the CEC bus with a pre-determined logic value; and
powering on the processing circuit when the CEC data is equal to the pre-determined logic value.

4. The method as claimed in claim 3, wherein the CEC data and the pre-determined logic value are compared through a logic circuit.

5. The method as claimed in claim 3, wherein the pre-determined logic value is loaded from the processing circuit into a storage device of the power management controller when the electronic system is started for the first time.

6. The method as claimed in claim 5, further comprising:
setting the processing circuit to a low power state after the pre-determined logic value has been loaded.

7. The method as claimed in claim 6, wherein the low power state is a power off state or a sleep state.

8. The method as claimed in claim 3, wherein the pre-determined logic value is stored in a storage device of the power management controller before the electronic system is started for the first time.

9. A method for starting an electronic system through CEC, the method comprising:
loading a pre-determined logic value into a storage device of a power management controller;
setting a processing circuit to a low power state after the pre-determined logic value has been loaded;
detecting a CEC bus which is electrically connected to the power management controller;
comparing a CEC data transmitted from the CEC bus with the pre-determined logic value; and
waking up the processing circuit when the CEC data is equal to the pre-determined logic value.

10. The method as claimed in claim 9, wherein the CEC data is compared with the pre-determined logic value through a logic circuit.

11. The method as claimed in claim 9, wherein the pre-determined logic value is loaded from the processing circuit into the storage device when the electronic system is started for the first time.

12. The method as claimed in claim 9, wherein the pre-determined logic value is loaded into the storage device through recording before the electronic system is started for the first time.

13. The method as claimed in claim 9, wherein the step of waking up the processing circuit is performed solely in response to when the CEC data is equal to the predetermined logic value.

14. The method as claimed in claim 9, wherein the low power state a power off state or a sleep state.

15. An electronic system, comprising:
a first electronic device which processes data and a plurality of instructions comprising:
a power management controller which controls power based on CEC data received from a CEC bus, wherein the power management controller comprises:
a storage device configured to store a pre-determined logic value; and
a logic circuit configured to compare the pre-determined logic value and the CEC data that is received; and
a processing circuit electrically connected to the power management controller and controlled to operate by the power management controller, wherein the processing circuit is set to a low power state after the pre-determined logic value is loaded into the storage device of the power management controller.

16. The electronic system as claimed in claim 15, wherein the processing circuit is woken up from the low power state to an operation state when the CEC data is determined to be equal to the pre-determined logic value.

17. The electronic system as claimed in claim 15, wherein the processing circuit comprises a main processor configured to process video data, audio data, and a plurality of instructions, wherein the main processor is not directly connected to the CEC bus.

18. The electronic system as claimed in claim 15, wherein the storage device is a flash memory or an electrically-erasable programmable read-only memory.

19. The electronic system as claimed in claim 15, wherein the logic circuit comprises a plurality of flip flops and a plurality of combinational circuits.

20. The electronic system as claimed in claim 15, wherein the power management controller further comprises:
at least one power device electrically connected to the logic circuit and the processing circuit, wherein the power device control supply of power for the processing circuit based on the comparison of the CEC data and the pre-determined logic value.

21. The electronic system as claimed in claim 20, wherein one of the power devices is a DC-DC converter.

22. The electronic system as claimed in claim 15, wherein the first electronic device is a TV, a system unit of a desktop computer, a processing part of a notebook, or a processing part of a smart phone.

23. The electronic system as claimed in claim 15, further comprising:
a second electronic device for outputting the CEC data to the first electronic device through the CEC bus.

24. The electronic system as claimed in claim 23, wherein the second electronic device is a multimedia player.

25. The electronic system as claimed in claim 23, wherein the second electronic device is a DVD player, a DVD recorder, a VCD player, a set top box, a videocassette recorder, a stereo player, a digital video recorder, a smart phone, a laptop, a desktop, or a game station.
